(19) United States
(12) Patent Application Publication
(10) Pub. No.: US 2024/0283655 A1
(43) Pub. Date: Aug. 22, 2024

(54) INFORMATION PROCESSING APPARATUS, INFORMATION PROCESSING METHOD AND NON-TRANSITORY COMPUTER-READABLE MEDIUM

(71) Applicant: CANON KABUSHIKI KAISHA, Tokyo (JP)

(72) Inventor: KAZUHIKO SUGIE, Kanagawa (JP)

(21) Appl. No.: 18/444,453

(22) Filed: Feb. 16, 2024

(30) Foreign Application Priority Data
Feb. 22, 2023 (JP) 2023-026415

(51) Int. Cl. H04L 9/32

(52) U.S. Cl. CPC H04L 9/3236; H04L 9/3247

(57) ABSTRACT

An information processing apparatus is provided. The information processing apparatus obtains image capturing plan information indicating a planned image capturing operation. The apparatus obtains image data obtained by image capturing. The apparatus generates an electronic signature for data including the image data and hash data obtained by performing hash processing on data including the image capturing plan information.

### BACKGROUND

### Field

The present disclosure relates to an information processing apparatus, an information processing method, and a program, and in particular to an image capturing operation.

### Description of the Related Art

A technique for inspecting a structure using a captured image instead of visually inspecting the structure is known. For example, Japanese Patent Laid-Open No. 2020-88647 discloses a technique for automatically detecting a defect such as a crack from images of concrete walls of infrastructure such as bridges, dams, and tunnels.

There is also known a technique related to authenticity certification that ensures that captured image data is not tampered with by electronically signing the captured image data. For example, Japanese Patent Laid-Open No. 2016-122917 describes that signature data is added to image data. Japanese Patent Laid-Open No. 2016-122917 also discloses adding a hash value of the first image data to the second image data as metadata in order to ensure relatedness between temporal image data.

### SUMMARY

According to an embodiment, an information processing apparatus obtains image capturing plan information indicating a planned image capturing operation, obtains image data obtained by image capturing, and generates an electronic signature for data including the image data and hash data obtained by performing hash processing on data including the image capturing plan information.

According to another embodiment, an information processing method comprises: obtaining image capturing plan information indicating a planned image capturing operation; obtaining image data obtained by image capturing; and generating an electronic signature for data including the image data and hash data obtained by performing hash processing on data including the image capturing plan information.

According to still another embodiment, a non-transitory computer-readable medium stores a program executable by a computer to perform a method comprising: obtaining image capturing plan information indicating a planned image capturing operation; obtaining image data obtained by image capturing; and generating an electronic signature for data including the image data and hash data obtained by performing hash processing on data including the image capturing plan information.

Further features of the present disclosure will become apparent from the following description of exemplary embodiments (with reference to the attached drawings).

### BRIEF DESCRIPTION OF THE DRAWINGS

FIG. 1 is a diagram illustrating an exemplary configuration of an information processing system according to an embodiment.

FIGS. 2A and 2B are views illustrating examples of hardware configurations of information processing apparatuses according to an embodiment.

FIG. 3 is a view illustrating an example of a functional configuration of the information processing apparatuses according to an embodiment.

FIG. 4 is a view illustrating an example of a description of content of an image capturing operation.

FIG. 5 is a view illustrating an example of file structures.

FIG. 6 is a flowchart of an information processing method according to an embodiment.

FIGS. 7A and 7B are views illustrating examples of screen displays in a camera.

FIG. 8 is a view illustrating an example of a functional configuration of an information processing apparatus according to an embodiment.

FIG. 9 is a flowchart of an information processing method according to an embodiment.

FIG. 10 is a view illustrating an example of file structures.

FIGS. 11A and 11B are views illustrating an example of file structures and an example of a description of content of an image capturing operation.

FIG. 12 is a view illustrating an example of a description of content of an image capturing operation.

FIGS. 13A and 13B are views illustrating an example of file structures.

### DESCRIPTION OF THE EMBODIMENTS

Hereinafter, embodiments will be described in detail with reference to the attached drawings. Note, the following embodiments are not intended to limit the scope of the claims. Multiple features are described in the embodiments, but limitation is not made to an embodiment that requires all such features, and multiple such features may be combined as appropriate. Furthermore, in the attached drawings, the same reference numerals are given to the same or similar configurations, and redundant description thereof is omitted.

An image capturing operation such as one for inspection of a structure may be performed in accordance with a plan created in advance. The planner of the image capturing operation may be different from the executer of the operation. In such a case, there is a possibility that a different operation from what is planned will be performed due to an error in conveying the plan, or the like. Such a possibility is increased if there are multiple operation steps. For this reason, due to the nature of inspection operations, it is useful to be able to verify that an image capturing operation has been performed with reference to a particular plan. In addition, it is useful to be able to verify that an image capturing operation has been performed with reference to a particular plan even for other image capturing operations that are not limited to inspection.

An embodiment of the present disclosure makes it possible to verify relatedness between a planned image capturing operation and a captured image obtained by image capturing.

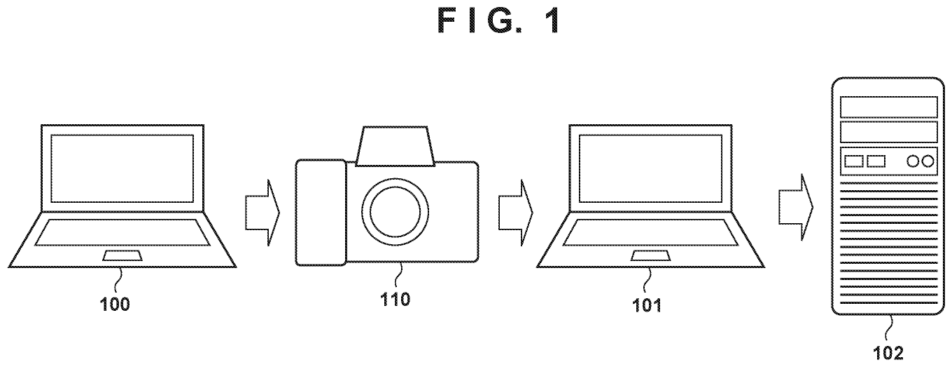

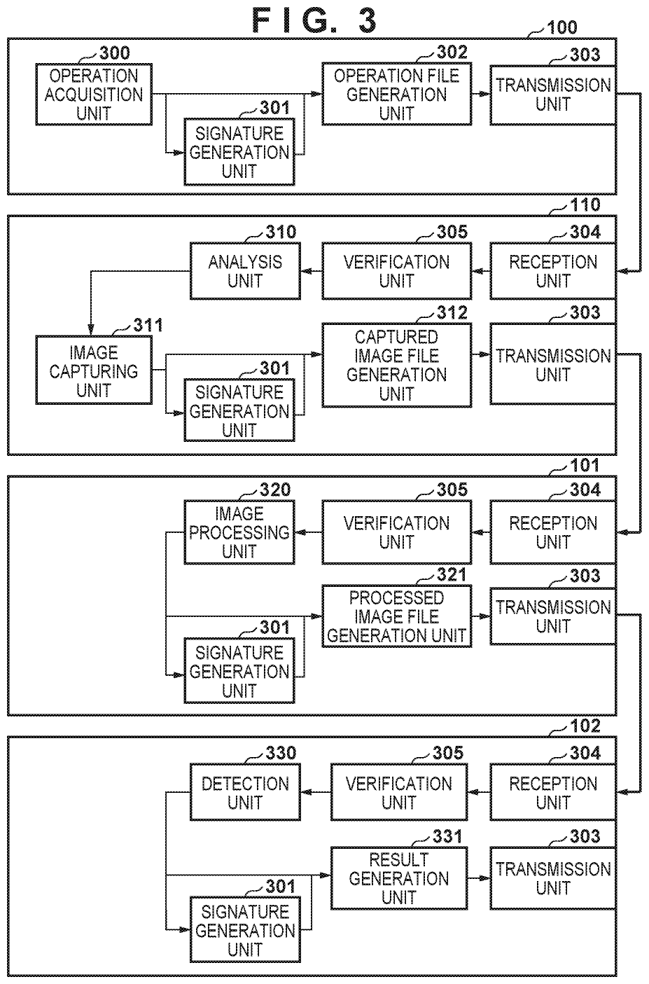

Hereinafter, an information processing system according to an embodiment will be described with reference to FIG. 1. The information processing system includes a plurality of information processing apparatuses. These information processing apparatuses can communicate with each other via a communication path such as a wireless LAN or a USB. Such an information processing apparatus can be realized by a computer including a processor and a memory. That is, a processor such as CPU 202 or 221 described below may execute a program stored in a memory such as memory 203 or 222, a data storage 204, or a non-volatile memory 223. Thus, the processor can realize functions of respective units illustrated in FIG. 3 and the like, which will be described later. However, some or all of the functions of each information processing apparatus may be realized by dedicated hardware. Further, an information processing apparatus according to an embodiment may be configured by a plurality of information processing apparatuses connected via a network, for example.

In the example of FIG. 1, the plurality of information processing apparatuses are PCs 100 to 102 and a camera 110. An application that executes a particular function is installed in the PC 100 in a predetermined OS (Operating System). Similarly, applications corresponding to functions to be realized are installed in the PC 101 and 102.

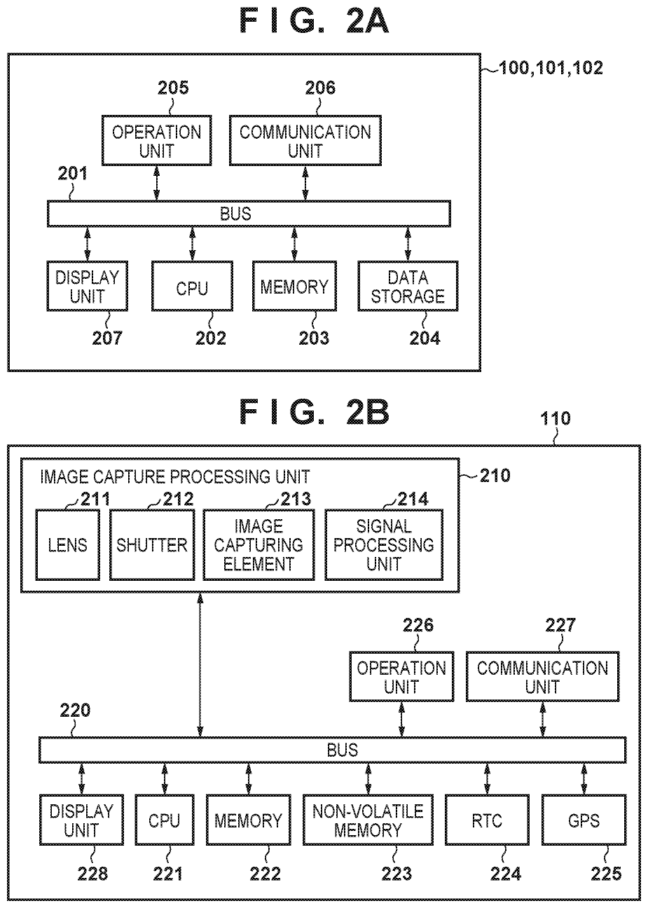

Referring to FIG. 2A, an exemplary hardware configuration of the PC 100 is illustrated. The PC 101 and the PC 102 may have a similar configuration to that of the PC 100.

A bus 201 interconnects each of the components in the PC 100. The CPU 202 is connected to each of the units in the PC 100 via the bus 201. The CPU 202 can comprehensively control each of the components in the PC 100.

The memory 203 temporarily stores data when various processes are performed by the respective components in the PC 100 such as the CPU 202. The data storage 204 stores programs or data executed by the CPU 202. The data storage 204 is, for example, a Hard Disk Drive (HDD) or a Solid State Drive (SSD).

An operation unit 205 receives an input from the user and notifies the CPU 202 of the input. In this way, the operation unit 205 realizes an operation of an application included in the PC 100. The operation unit 205 is, for example, a keyboard.

A communication unit 206 exchanges data with an apparatus outside the PC 100. The communication unit 206 is, for example, a transmission/reception unit supporting a wireless LAN or a USB.

A display unit 207 may display information and data of an application operating in the PC 100. The display unit 207 is, for example, a liquid crystal display. Meanwhile, the information and data may be displayed on an external display apparatus via the communication unit 206.

FIG. 2B illustrates an example of a hardware configuration of the camera 110. An image capture processing unit 210 includes a lens 211, a shutter 212, an image capturing element 213, and a signal processing unit 214. The image capture processing unit 210 outputs captured data such as a still image, a moving image, or live view display data to the memory 222. The lens 211 forms a subject image on the image capturing element 213. The lens 211 may be interchangeable. The shutter 212 can adjust the exposure period. The shutter 212 is, for example, a focal plane shutter. Meanwhile, the image capturing element 213 may have an electronic shutter function for adjusting the exposure period. The image capturing element 213 performs photoelectric conversion for converting an optical image of a subject into data. The image capturing element 213 may be, for example, a CMOS sensor.

The signal processing unit 214 performs various types of image processing on the image data transferred from the image capturing element 213. The signal processing unit 214 can perform processing such as white balance adjustment, color interpolation, gamma correction, edge enhancement, resolution conversion, noise reduction, or data compression processing.

A bus 220 interconnects each of the components in the camera 110. The CPU 221 controls each of the components in the camera 110 overall. The CPU 221 is connected to each of the units in the camera 110 via the bus 220.

The memory 222 stores image data output from the image capture processing unit 210. In addition, the memory 222 temporarily stores data when the CPU 221 performs various processes. The non-volatile memory 223 stores programs executed by the CPU 221.

An RTC 224 manages time. For example, the RTC 224 may generate time data indicating the present time. Even when the camera 110 is powered OFF, the RTC 224 can continue to manage time. A GPS 225 may measure the position of the camera 110. For example, the GPS 225 receives a GPS signal from a satellite and acquires position information of the camera 110 based on the received signal.

An operation unit 226 is used by a user to give an instruction to the camera 110. The operation unit 226 is, for example, a power button, an image capturing instruction button, a touch panel, or the like.

A communication unit 227 exchanges data with an apparatus external to the camera 110. The communication unit 227 is, for example, a wireless LAN transmission/reception unit or a USB or the like. In addition, the communication unit 227 may be capable of performing short-range wireless communication. For example, the communication unit 227 may be capable of reading a Radio Frequency Identification (RFID) tag or the like.

A display unit 228 can display the image data outputted by the image capture processing unit 210 or a menu selectable by the user. The display unit 228 is, for example, a liquid crystal display.

In the PC 100 to 102 and the camera 110, robust security can also be realized. For example, the CPU 202 and 221 may have a secure implementation such as Trusted Execution Environment (TEE). In addition, the PC 100 to 102 and the camera 110 may include a secure recording medium such as a Trusted Platform Module (TPM). A private key used for the electronic signature described below is stored in the data storage 204 or the non-volatile memory 223 in one embodiment. However, by storing the private key in a TPM, the private key can be managed more securely.

In the embodiments described below, the PC 100 is used for planning an image capturing operation. For example, the user enters content of the planned image capturing operation into the PC 100. Then, the PC 100 generates image capturing plan information indicating the planned image capturing operation. In this case, the PC 100 generates an operation file in which the image capturing plan information is described, and transmits the operation file to the camera 110.

The camera 110 receives the operation file. Then, image capturing using the camera 110 is performed with reference to the image capturing plan information. In addition, the camera 110 creates a captured image file including a captured image obtained by image capturing. Then, the camera 110 transmits the captured image file to another information processing apparatus. The other information processing apparatus can perform image processing or detection processing on the image data. In the following embodiment, the camera 110 transmits the captured image file to the PC 101.

The PC 101 and the PC 102 can process captured images obtained by the camera 110. For example, the PC 101 receives a captured image file from the camera 110. Then, the PC 101 can composite a plurality of captured images or edit a captured image. Then, the PC 101 transmits to the PC 102 the processed image file including the image obtained by the compositing or editing as described above. The PC 102 can perform a detection process on an image included in the received processed image file. In the detection process, for example, a defect in a subject in an image is detected.

Here, the PC 100, the camera 110, the PC 101, and the PC 102 can electronically sign a file (or a part of data in the file) to be outputted. An electronic signature indicates that the files are authentic data generated by the PC 100, the PC 101, the PC 102, or the camera 110. In the following explanation, processing performed by two or more of the PC 100, the camera 110, the PC 101, and the PC 102 may be performed by a single information processing apparatus. Also, in the following explanation, processing performed by two or more of the PC 100, the camera 110, the PC 101, and the PC 102 may be performed by a plurality of apparatuses. For example, the image processing apparatus according to the embodiment of the present disclosure may be configured by a plurality of information processing apparatuses connected via a network, for example. In this case, each of the plurality of apparatuses may electronically sign the output.

FIG. 3 illustrates an exemplary functional configuration of the PCs 100 to 102 and the camera 110. The same reference numerals are given to the functional units common to the respective apparatuses. The functional units denoted by the same reference numerals can perform similar processing.

The PC 100 includes an operation acquisition unit 300, a signature generation unit 301, an operation file generation unit 302, and a transmission unit 303. The operation acquisition unit 300 performs a plan acquisition process of acquiring image capturing plan information indicating a planned image capturing operation. For example, the operation acquisition unit 300 can receive an input of contents of a scheduled image capturing operation. The operation acquisition unit 300 can then digitize the contents of the inputted image capturing operation. The image capturing plan information may include, for example, information indicating a scheduled image capturing period, a scheduled image capturing position, or an object scheduled to be captured.

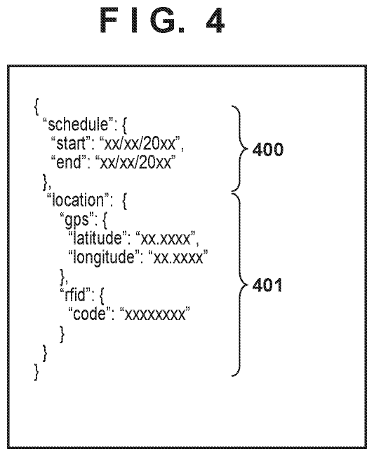

FIG. 4 illustrates an example of content of an image capturing operation described in JavaScript Object Notation (JSON) format. The image capturing plan information may indicate a scheduled image capturing period. For example, an item 400 indicates a start date and an end date of the image capturing operation. The item 400 specifies that the image capturing operation is to be performed between the start date and the end date. In addition, the image capturing plan information can indicate a location of a subject whose image is scheduled to be captured. The image capturing plan information may indicate a method of confirming an image capturing target. For example, an item 401 specifies confirming the position by positioning with GPS, and specifies the latitude and longitude of the subject. In addition, the item 401 specifies confirming the image capturing target using an RFID, and specifies an ID of an RFID tag embedded in the image capturing target.

The operation acquisition unit 300 may acquire image capturing plan information described in JSON format. Meanwhile, the operation acquisition unit 300 may convert the content of the image capturing operation inputted on a dedicated application into image capturing plan information in JSON format. In addition, the format of the image capturing plan information is not limited to JSON format. For example, the image capturing plan information may be described in Extensible Markup Language (XML) format. Furthermore, the image capturing plan information may indicate not only a planned image capturing operation but also a plan of an operation to be performed after the image capturing operation. For example, the image capturing plan information may indicate a scheduled date and time of an image processing operation (for example, an editing operation) on an image.

The signature generation unit 301 signs the data. For example, the signature generation unit 301 of the PC 100 can signs data including the image capturing plan information acquired by the operation acquisition unit 300. The signature generation unit 301 can sign data in accordance with a public key encryption scheme. The encryption scheme used by the signature generation unit 301 is not particularly limited, and for example, an RSA scheme can be used.

First, the signature generation unit 301 can generate a hash value for some or all of the data to be signed. That is, the signature generation unit 301 can generate a hash value for data within a predetermined reference range. The function used by the signature generation unit 301 to generate the hash value is not particularly limited. For example, the signature generation unit 301 may generate a hash value using a cryptographic hash function such as SHA-256. In addition, the signature generation unit 301 can perform electronic signing by encrypting the obtained hash value with a secret key. An encryption key used by the signature generation unit 301 is held in each apparatus.

The operation file generation unit 302 generates an operation file including image capturing plan information. In the present embodiment, the operation file generation unit 302 generates an operation file by using the image capturing plan information acquired by the operation acquisition unit 300 and the electronic signature generated by the signature generation unit 301. The structure of the operation file will be described later. The transmission unit 303 transmits the data to the related apparatus. The function of the transmission unit 303 is mainly realized by the communication unit 206 or the communication unit 227. The transmission unit 303 of the PC 100 transmits the image capturing plan information indicating the planned image capturing operation to the camera 110. In present example, the transmission unit 303 of the PC 100 may transmit the operation file generated by the operation file generation unit 302 to the camera 110.

The camera 110 includes a reception unit 304, a verification unit 305, an analysis unit 310, an image capturing unit 311, the signature generation unit 301, a captured image file generation unit 312, and the transmission unit 303. The reception unit 304 receives data transmitted from an associated apparatus. The function of the reception unit 304 is mainly realized by the communication unit 206 or the communication unit 227. The reception unit 304 of the camera 110 acquires image capturing plan information indicating the planned image capturing operation. The reception unit 304 of the camera 110 can receive the operation file from the PC 100. In this example, the image capturing plan information is written into the operation file that is received by the camera 110 as described above, and an electronic signature by the PC 100 is further added to the operation file.

The verification unit 305 verifies the authenticity of the data. For example, the verification unit 305 generates a hash value of data that is a target of the electronic signature. Further, the verification unit 305 generates a hash value from the electronic signature using the public key. The verification unit 305 can verify the presence or absence of tampering with the data by comparing the two generated hash values. The verification unit 305 can perform such verification using the same algorithm as the signature generation unit 301. That is, the verification unit 305 can generate a hash value for data within the same reference range as the signature generation unit 301. In addition, the verification unit 305 generates a hash value using a public key paired with the private key used by the signature generation unit 301.

In the present embodiment, the verification unit 305 verifies the authenticity of the file generated by the related apparatus. For example, the verification unit 305 of the camera 110 verifies the authenticity of the operation file generated by the PC 100. In this case, the public key corresponding to the private key of the associated apparatus is used. Such a public key may be held inside each apparatus in advance. Also, the public key may be acquired from an associated apparatus by communication.

The analysis unit 310 analyzes image capturing plan information. For example, the analysis unit 310 acquires each of the items included in the operation file by analyzing the operation file received from the PC 100.

The image capturing unit 311 performs image acquisition processing for acquiring image data obtained by image capturing. The image capturing unit 311 may be realized by the image capture processing unit 210. The image capturing element 213 included in the image capture processing unit 210 is used to generate such image data. The image capturing unit 311 can acquire image data such as a still image or a moving image. In the present embodiment, the image capturing by the image capturing unit 311 is performed with reference to the image capturing operation indicated by the image capturing plan information.

Further, the image capturing unit 311 can generate metadata including data obtained based on the image capturing plan information acquired by the reception unit 304. In one embodiment, the metadata includes data obtained through a hash process on the data including the image capturing plan information. For example, the image capturing unit 311 can generate metadata based on the operation file. Examples of the metadata based on the operation file include an electronic signature included in the operation file. As described above, this electronic signature is an electronic signature on data including image capturing plan information. Therefore, the electronic signature corresponds to data obtained based on the image capturing plan information acquired by the reception unit 304. The electronic signature also corresponds to data obtained through a hash process on the data including the image capturing plan information acquired by the reception unit 304.

Also, the image capturing unit 311 can generate metadata related to an image. For example, the image capturing unit 311 may generate metadata including an image capturing time, an image capturing location (for example, GPS information), or an image capturing setting (for example, a shutter value).

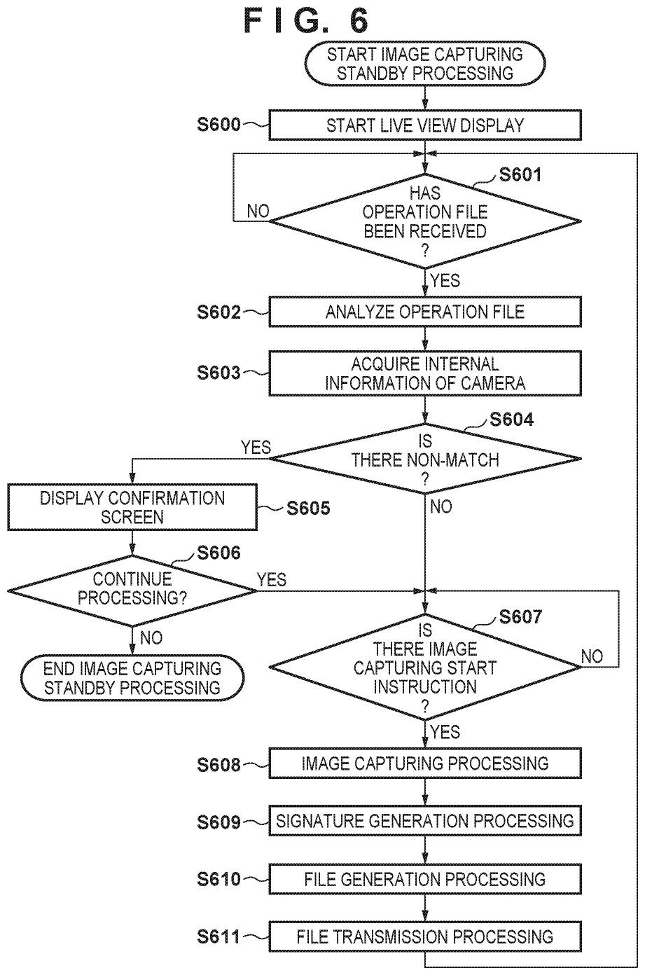

Note that the image capturing unit 311 may determine whether or not image capturing conforms to a planned image capturing operation. Such a configuration will be described later with reference to the flowchart of FIG. 6.

The signature generation unit 301 of the camera 110 generates an electronic signature for the data including both the image data and the data obtained based on the image capturing plan information acquired by the reception unit 304. In the present embodiment, the signature generation unit 301 of the camera 110 generates an electronic signature for data including both the image data and metadata including data based on the image capturing plan information.

The captured image file generation unit 312 generates a captured image file including image data. In the present embodiment, the captured image file generation unit 312 generates a captured image file using image data acquired by the image capturing unit 311, metadata generated by the image capturing unit 311, and an electronic signature generated by the signature generation unit 301 of the camera 110. The structure of the captured image file will be described later.

The transmission unit 303 of the camera 110 transmits to the PC 101 the image data acquired by the image capturing unit 311, the metadata generated by the image capturing unit 311, and the electronic signature generated by the signature generation unit 301 of the camera 110. In the present embodiment, the transmission unit 303 of the camera 110 transmits to the PC 101 the captured image file generated by the captured image file generation unit 312.

The PC 101 includes the reception unit 304, the verification unit 305, an image processing unit 320, a processed image file generation unit 321, the signature generation unit 301, and the transmission unit 303. The reception unit 304 of the PC 101 acquires a captured image file from the camera 110. The verification unit 305 of the PC 101 verifies the authenticity of the captured image file.

The image processing unit 320 performs image processing on image data obtained by the camera 110. For example, the image processing unit 320 can composite a plurality of images obtained by the camera 110. In addition, the image processing unit 320 can perform editing processing for obtaining an image suitable for image detection processing described later. The image processing may be, for example, correction processing or cropping processing.

In addition, the image processing unit 320 can generate metadata based on the captured image file transmitted from the camera 110. Examples of the metadata based on the captured image file include an electronic signature included in the captured image file. Also, the image processing unit 320 can generate metadata related to image processing. For example, the image processing unit 320 can generate metadata including the editing date and time, the content of the editing process, and the like.

The signature generation unit 301 of the PC 101 generates an electronic signature for data including the image data generated by the image processing unit 320 and data based on the captured image file. In the present embodiment, the signature generation unit 301 of the PC 101 generates an electronic signature for data including a set of image data and metadata that are generated by the image processing unit 320.

The processed image file generation unit 321 generates a processed image file using the image data generated by the image processing unit 320, the metadata generated by the image processing unit 320, and the electronic signature generated by the signature generation unit 301 of the PC 101. The structure of the processed image file will be described later. The transmission unit 303 of the PC 101 transmits to the PC 102 the image data generated by the image processing unit 320, the metadata generated by the image processing unit 320, and the electronic signature generated by the signature generation unit 301 of the PC 101. In the present embodiment, the transmission unit 303 of the PC 101 transmits to the PC 102 the processed image file generated by the processed image file generation unit 321.

In this example, the image processing unit 320 of the PC 101 both composites and edits the images. Meanwhile, the information processing system may include each of an apparatus that performs image composition and an apparatus that performs image editing. When the functions of the PC 101 are realized by a plurality of apparatuses as described above, it is possible to electronically sign the data transmitted by each of the apparatuses. Such a method enables more strict management of data.

The PC 102 includes the reception unit 304, the verification unit 305, a detection unit 330, a result generation unit 331, the signature generation unit 301, and the transmission unit 303. The reception unit 304 of the PC 102 acquires a processed image file from the PC 101. The verification unit 305 of the PC 102 verifies the authenticity of the processed image file.

The detection unit 330 performs detection processing on image data generated by the PC 101. The detection unit 330 may detect, for example, a particular feature in the image or a particular type of object in the image. In the present embodiment, the detection unit 330 detects a defect in the subject that is the inspection target. The method of the detection processing is not particularly limited. For example, the detection unit 330 can detect a defect based on a comparison of an image of a subject acquired from the PC 101 with an image of the same subject captured in the past. Further, the detection unit 330 may detect a defect using training data. The training data may be, for example, a trained model such as a neural network. The training data may be created in advance based on a plurality of pieces of image data indicating a defect. Furthermore, the detection unit 330 generates data indicating a detection result. The detection result may indicate, for example, the presence or absence of a defect in the subject that is the inspection target and the size of the defect. If the subject that is the inspection target is concrete and a crack is detected as a defect, the detection result may indicate the width or length of the crack.

In addition, the detection unit 330 can generate metadata based on the processed image file transmitted from the PC 101. Examples of the metadata based on the processed image file include an electronic signature included in the processed image file. Also, the detection unit 330 can generate metadata related to a detection process. For example, the detection unit 330 can generate metadata including the date and time of the detection process, parameters used in the detection process, and the like.

The signature generation unit 301 of the PC 102 generates an electronic signature for data including the image data generated by the detection unit 330 and data based on the processed image file. In the present embodiment, the signature generation unit 301 of the PC 102 generates an electronic signature for the data including a set of image data and metadata generated by the image processing unit 320.

The result generation unit 331 generates a detection result file using the image data generated by the detection unit 330, the metadata generated by the detection unit 330, and the electronic signature generated by the signature generation unit 301 of the PC 102. The structure of the detection result file will be described later. The transmission unit 303 of the PC 102 outputs the image data generated by the detection unit 330, the metadata generated by the detection unit 330, and the electronic signature generated by the signature generation unit 301 of the PC 102.

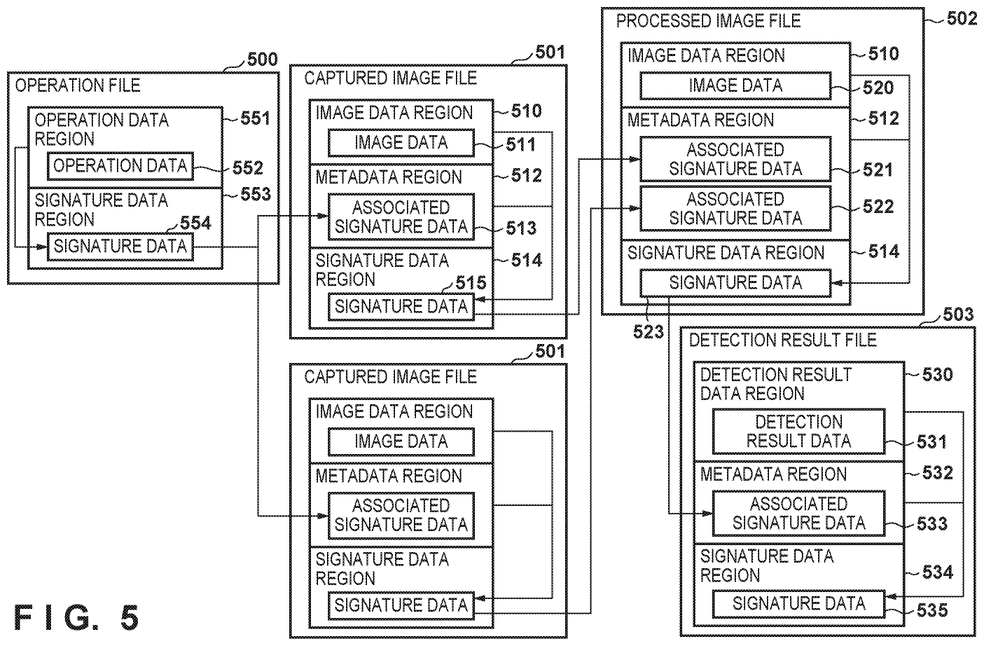

Referring now to FIG. 5, the structure of files outputted by the PCs 100 to 102 and the camera 110 and relatedness between the files will be described. An operation file 500 is outputted from the PC 100 and inputted to the camera 110. The operation file 500 includes an operation data region 551 and a signature data region 553. The operation data region 551 includes at least operation data 552. The operation data 552 indicates the above-described image capturing plan information. The operation data 552 is, for example, data illustrated in FIG. 4. The signature data region 553 includes signature data 554. The signature data 554 is an electronic signature generated by the signature generation unit 301 of the above-described the PC 100. The signature data 554 is obtained using a hash value for a part of or all of the operation data region 551.

A captured image file 501 is outputted from the camera 110 and inputted to the PC 101. The captured image file 501 includes an image data region 510, a metadata region 512, and a signature data region 514. The image data region 510 includes at least image data 511. The image data 511 is image data acquired by the image capturing unit 311. The image data region 510 may include data for a plurality of images. For example, the image data region 510 may include image data other than the image data 511. The image data region 510 may include data composed of a plurality of frames, such as moving image data.

In present embodiment, the metadata region 512 includes at least associated signature data 513. The associated signature data 513 is an electronic signature of an associated file of the captured image file 501. “Associated file” refers to a file that is referenced to generate a file. In this example, the captured image file 501 is obtained as a result of the image capturing performed with reference to the operation file 500. Therefore, the associated file for the captured image file 501 is the operation file 500. Accordingly, the associated signature data 513 indicates the signature data 554 included in the operation file 500.

The signature data region 514 includes signature data 515. The signature data 515 is an electronic signature generated by the signature generation unit 301 of the above-described camera 110. The signature data 554 is obtained using a hash value for a part of or all of the image data region 510 and the metadata region 512. Note that the camera 110 may perform a plurality of image captures in a series of operations according to the operation file 500. In this case, the camera 110 can generate a plurality of captured image files. At this time, the associated signature data 513 of each captured image file 501 is the signature data 554 of the same operation file 500.

A processed image file 502 is outputted from the PC 102 and inputted to the PC 101. The configuration of the processed image file 502 is similar to that of the captured image file 501. For example, the image data region 510 includes image data 520 obtained by image processing. The metadata region 512 includes data based on the associated file of the processed image file 502. In this example, the processed image file 502 is obtained as a result of image processing using the captured image file 501. Therefore, the associated file for the processed image file 502 is the captured image file 501. Accordingly, the metadata region 512 may include data based on the captured image file 501. In the example of FIG. 5, the metadata region 512 includes associated signature data, which is an electronic signature for the captured image file 501. The signature data region 514 includes signature data 523. The signature data 523 is an electronic signature generated by the signature generation unit 301 of the above-described PC 101. The signature data 523 is obtained similarly to the signature data 515.

Note that the PC 102 can composite the images indicated in each of a plurality of captured image files 501. In this case, the PC 102 may then generate one processed image file 502 based on the plurality of captured image files 501. At this time, the metadata region 512 may include a plurality of pieces of associated signature data. In the example of FIG. 5, the processed image file 502 is obtained based on the two captured image files 501. The metadata region 512 includes two pieces of associated signature data 521 and 522. The associated signature data 521 indicates signature data included in one captured image file 501, and the associated signature data 522 indicates signature data included in another captured image file 501.

A detection result file 503 is outputted from the PC 102. The detection result file 503 includes a detection result data region 530, a metadata region 532, and a signature data region 534. The detection result data region 530 includes detection result data 531. The detection result data 531 indicates a detection result generated by the detection unit 330. The metadata region 532 includes data based on the associated file of the detection result file 503. In this example, the associated file for the detection result file 503 is the processed image file 502. Accordingly, the metadata region 532 may include data based on the processed image file 502. In the example of FIG. 5, the metadata region 532 includes associated signature data 533, and the associated signature data 533 is an electronic signature for the processed image file 502. The signature data region 534 includes signature data 535. The signature data 535 is an electronic signature generated by the signature generation unit 301 of the above-described PC 102. The signature data 535 is obtained using a hash value for a part of or all of the detection result data region 530 and the metadata region 532.

Next, a flow of processing performed by the camera 110 will be described with reference to FIG. 6. In step S600, the camera 110 starts displaying a live view. In step S601, the reception unit 304 waits for reception of an operation file from the PC 100. If the operation file has not been received, step S601 is repeated. Upon receiving the operation file, the process proceeds to step S602.

In step S602, the verification unit 305 verifies the signature of the operation file received in step S601. The analysis unit 310 analyzes the operation file received in step S601. In this example, the analysis unit 310 analyzes the operation file, which includes the data illustrated in FIG. 4, to acquire information indicating the scheduled image capturing period and the location of the subject scheduled to be captured.

In step S603 to step S606, the image capturing unit 311 determines whether or not image capturing conforms to a planned image capturing operation. The process of step S603 to step S606 can be changed according to the content of the image capturing plan.

In step S603, the image capturing unit 311 acquires internal information about the camera 110. In present example, the image capturing unit 311 acquires the time information managed by the camera 110 from the RTC 224. Also, the image capturing unit 311 acquires positioning information of the camera 110 from the GPS 225. In step S604, the image capturing unit 311 compares the information acquired from the operation file in step S602 with the internal information of the camera obtained in step S603. If the information matches, the process proceeds to step S607. If there is a non-matching item, the process proceeds to step S605.

The image capturing unit 311 may in this way determine whether or not image capturing conforms to a planned image capturing operation. For example, the image capturing unit 311 can perform such a determination by comparing the current time with the scheduled image capturing period indicated in the image capturing plan information. Also, the image capturing unit 311 can perform such a determination by comparing the current position and the scheduled image capturing position indicated in the image capturing plan information. Furthermore, the image capturing unit 311 can perform such a determination by comparing information related to the subject of the image capturing with the information indicating the target of scheduled image capturing indicated in the image capturing plan information. For example, a communication device such as an RFID tag may be attached to the subject. In this case, the information about the subject whose image is to be captured may be information received from the communication device, e.g., an ID of the RFID tag. The information about the subject is not limited to such an example, and may be, for example, a result of recognizing a barcode added to the subject.

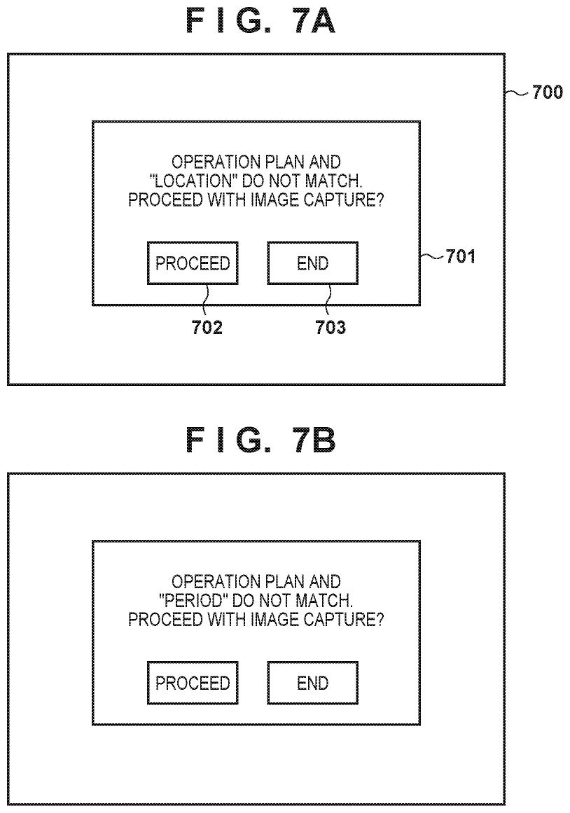

In step S605, the image capturing unit 311 notifies that the image capturing to be performed does not conform to the planned image capturing operation. For example, the image capturing unit 311 can notify the user of a non-matching item. Specifically, the image capturing unit 311 can display a non-matching item on the display unit 228. FIG. 7A illustrates an example of a screen displayed in a case where the location indicated in the operation file does not match the location that the internal information of the camera indicates. A screen 700 is a live view screen. The screen 700 includes a region 701 indicating a non-matching item. The region 701 also includes buttons 702 and 703. The buttons 702 and 703 indicates options for operation of the camera 110. FIG. 7B illustrates an example of a screen that is displayed when the present time indicated by the internal information of the camera is not within the scheduled image capturing period illustrated in the operation file.

In step S606, the image capturing unit 311 receives a user input regarding the operation of the camera 110. In the example of FIG. 7A, the image capturing unit 311 receives a selection indicating whether the operation is to be continued or ended. Here, when the user presses the button 702, the process proceeds to step S607, and the processing for image capturing continues. When the user presses the button 703, the image capturing standby process ends.

In step S607, the image capturing unit 311 determines whether or not a user's operation to start image capturing has been performed. When a user's operation to start image capturing has not been performed, step S607 is repeated. When a user's operation to start the image capturing has been performed, the process proceeds to step S608.

In step S608, the image capturing unit 311 generates image data and metadata. The image data is data included in the image data region 510 illustrated in FIG. 5. Also, the metadata is data included in the metadata region 512 illustrated in FIG. 5. As described above, the image capturing unit 311 can include data obtained based on the image capturing plan information in the metadata. For example, the image capturing unit 311 may include the associated signature data 513 in the metadata.

In addition, when the image capturing is performed even though non-matching data is detected in step S606, the image capturing unit 311 can generate data indicating that the performed image capturing does not conform to the planned image capturing operation. The image capturing unit 311 can add such information to the metadata in addition to the data obtained based on the image capturing plan information. The image capturing unit 311 may add information indicating a non-matching item to the metadata.

In step S609, the signature generation unit 301 generates an electronic signature as described above based on the image data and the metadata generated by the image capturing unit 311. In step S610, the captured image file generation unit 312 generates the captured image file 501 having the configuration illustrated in FIG. 5 as described above. In step S611, the transmission unit 303 transmits the captured image file 501 generated in step S610 to a unit external to the camera 110. Thereafter, the process returns to step S601.

The above-described image capturing operation using the camera 110 can be performed with reference to the image capturing plan information generated by the PC 100. In one embodiment, information indicating the image capturing plan information acquired by the camera 110 may be notified to the operator of the camera 110 via the display unit 228 or the like. Meanwhile, the operator of the camera 110 may refer to the image capturing plan information by another method such as an instruction manual. In any case, the captured image file outputted by the camera 110 includes data obtained based on the image capturing plan information referred to by the operator of the camera 110. The data is given the electronic signature by the camera 110. Therefore, it is possible to verify the relatedness between the captured image file and the operation file. That is, it is possible to check whether or not the data based on the image capturing plan information (e.g., the electronic signature included in the operation file) generated based on the operation file matches the data based on the image capturing plan information (e.g., the associated signature data) included in the captured image file. The matching here indicates that the captured image file was obtained by an image capturing operation performed with reference to the operation file.

Note that the captured image file outputted by the camera 110 may include image capturing plan information acquired by the camera 110. In this case, by verifying the electronic signature of the captured image file, it is possible to confirm that the captured image file is obtained by the image capturing operation performed with reference to the specific image capturing plan.

In the above-described embodiment, the image capturing plan information is electronically signed by the PC 100. Therefore, it is possible to confirm that the captured image file is obtained by the image capturing operation performed with reference to authentic image capturing plan information outputted by the PC 100. However, it is not essential that the image capturing plan information be electronically signed by the PC 100 in order to confirm that a captured image file is obtained by an image capturing operation performed with reference to a particular image capturing plan.

Furthermore, as described above, the camera 110 may determine whether or not image capturing conforms to a planned image capturing operation. Then, the camera 110 can add information indicating the determination result to the captured image file together with data based on the image capturing plan information. According to such a configuration, it is possible to verify that the image capturing is performed in accordance with the planned image capturing operation. Further, according to such a configuration, it is possible to reduce an error caused by the operator of the camera 110 in the image capturing operation. Meanwhile, the determination as to whether or not the image capturing operation conforms to the planned image capturing operation can be performed by another information processing apparatus (e.g., a PC 800) as will be described later. In such a configuration, the image capturing unit 311 can add data indicating the performed image capturing operation to the metadata in addition to the data obtained based on the image capturing plan information. The data indicating the performed image capturing operation may include, for example, an image capturing time, an image capturing position, or information indicating an image capturing target.

The processing performed by the camera 110 has been described so far. However, the PC 101 and the PC 102 can also generate a processed image file and a detection result file by performing similar processing. That is, the PC 101 or the PC 102 can add the data based on an associated file to a processed image file or a detection result file. Further, an electronic signature can be added to data based on the associated file. According to such a configuration, it is possible to confirm that the processed image file or the detection result file is obtained based on a particular associated file (for example, a captured image file or a processed image file).

In addition, as described above, the image capturing plan information may indicate a plan of an image processing operation for an image. In this case, the PC 101 or the PC 102 can determine whether the image processing operation conforms to the planned image processing operation. Then, the PC 101 or the PC 102 can add information indicating the determination result to the processed image file or the detection result file together with data based on associated file. According to such a configuration, it is possible to verify that the image processing operation is performed in accordance with the planned image capturing operation.

As described above, by virtue of the present embodiment, it becomes possible to verify relatedness between a planned image capturing operation and a captured image obtained by image capturing. In particular, according to the above-described example, when a plurality of apparatuses respectively perform processing, it is possible to verify the relatedness between files outputted by the respective apparatuses.

In the above-described embodiment, a configuration has been described in which the relatedness of an operation file, a captured image file, a processed image file, and a detection result file can be verified. However, the target of the processing may be a period from when the image capturing plan information is generated to when the image capturing is performed. In such an embodiment, it is possible to confirm the relatedness between image capturing plan information (or an operation file) and image data (or a captured image file).

### (File Verification)

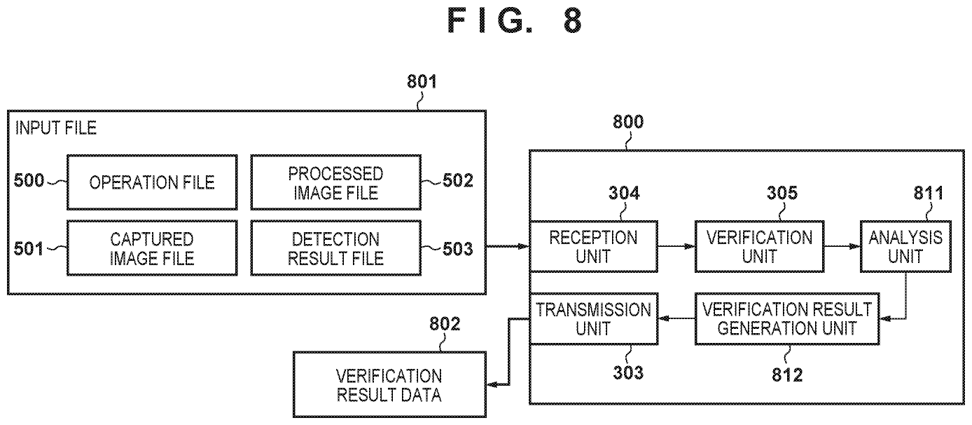

A method of verifying the relatedness of each file will be described below. The PC 800, which is an information processing apparatus according to the embodiment, can verify the relatedness of respective files. Referring to FIG. 8, the PC 800 will be described.

An input file 801 is inputted to the PC 800. The input file 801 includes the operation file 500 outputted by the PC 100, the captured image file 501 outputted by the camera 110, the processed image file 502 outputted by the PC 101, and the detection result file 503 outputted by the PC 102. The PC 800 verifies the relatedness between these files. Then, the PC 800 outputs the verification result as verification result data 802. The PC 800 may have the hardware configuration illustrated in FIG. 2A.

The PC 800 includes the transmission unit 303, the reception unit 304, the verification unit 305, an analysis unit 811, and a verification result generation unit 812. Functional units having the same functions as those of the functional units of the PCs 100 to 102 are denoted by the same reference numerals as those of the functional units of the PCs 100 to 102.

The reception unit 304 acquires the above input file 801. The verification unit 305 verifies the authenticity of each piece of data included in the input file 801.

The analysis unit 811 verifies the relatedness of each piece of data included in the input file 801. For example, as described above, the captured image file 501 may include metadata based on the operation file 500. In this case, the analysis unit 811 confirms that the metadata included in the captured image file 501 included in the input file 801 is metadata based on the operation file 500 included in the input file 801. In this way, the analysis unit 811 can verify the relatedness between the operation file 500 included in the input file 801 and the captured image file 501. In the example of FIG. 5, each file includes associated signature data. In this case, the analysis unit 811 can also confirm that there is a file having signature data that matches the associated signature data included in each file.

The analysis unit 811 can analyze the contents of each file included in the input file 801. Then, the analysis unit 811 may confirm the consistency of the information obtained from each file. For example, the analysis unit 811 can verify whether the scheduled image capturing period indicated in the operation file 500 matches the image capturing date and time indicated in the captured image file 501.

The verification result generation unit 812 generates the verification result data 802. The verification result data 802 may include information obtained by the verification unit 305 and indicating a result of detection of tampering for each file included in the input file 801. In addition, the verification result data 802 may include a result of verification of the relatedness of each piece of data obtained by the analysis unit 811. The verification result data 802 may include a result of verification of the consistency of the information obtained from each file obtained by the analysis unit 811. Note that it is possible to electronically sign the verification result data 802. For example, in a case where the verification result data 802 is distributed, it is possible to electronically sign the verification result data 802. The transmission unit 303 outputs the verification result data 802 obtained in this way.

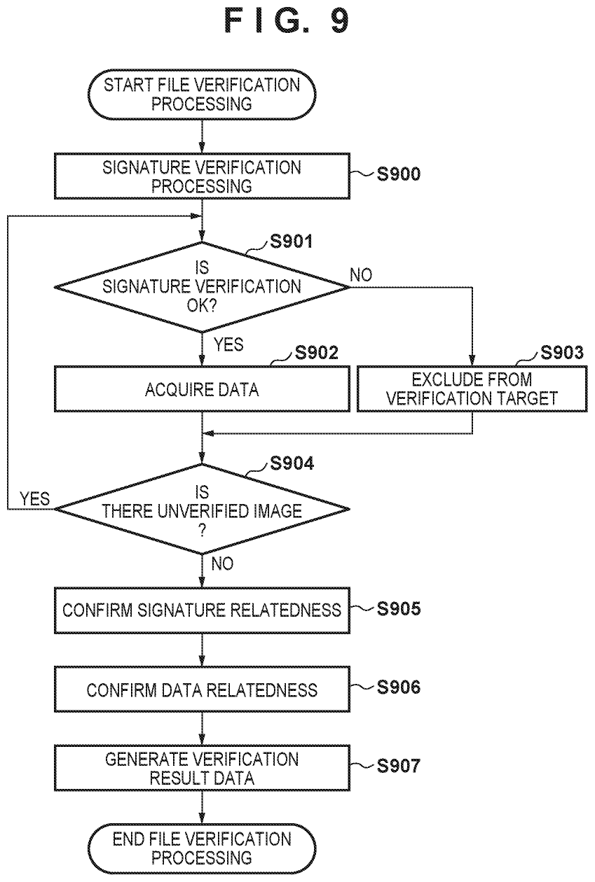

Next, a flow of processing performed by the PC 800 will be described with reference to FIG. 9. When the PC 800 receives the input file 801, the file verification process illustrated in FIG. 9 starts. First, in step S900, the verification unit 305 verifies an electronic signature on one file included in the input file 801. The PC 800 may store in advance the public keys of each apparatus used to verify the electronic signatures. In addition, the PC 800 may acquire the public keys of the respective apparatuses via communication.

If the verification in step S900 does not detect file tampering, the processing proceeds from step S901 to step S902. If file tampering is detected, the process proceeds from step S901 to step S903. If no electronic signature is added to the file, the file can be treated similarly to a tampered file.

In step S902, the analysis unit 811 acquires the content of the data included in the file that was the verification target in step S900. In step S903, the verification unit 305 excludes the file that was the verification target in step S900 from subsequent analysis. Files excluded in this way are excluded from the search target in step S905.

In step S904, the verification unit 305 determines whether or not electronic signature verification has been performed for all files included in the input file 801. If there is a file that has not been verified, the process returns to step S900. Then, the electronic signature of another file is verified. If the electronic signature has been verified for all the files included in the input file 801, the processing proceeds to step S905.

In step S905, the analysis unit 811 confirms the relatedness of files included in the input file 801. As described above, each file has data based on an associated file as metadata. The analysis unit 811 can confirm that there is relatedness between a certain file and another file in a case where the data based on associated file of the certain file matches the data based on the other file. In this example, the analysis unit 811 confirms the relatedness of the signatures between the files included in the input file 801. Specifically, the analysis unit 811 searches for another file having signature data that matches the associated signature data included in a certain file. When such a file is found, the analysis unit 811 determines that there is relatedness between the certain file and the other file. If another file having relatedness to a certain file is not found, the analysis unit 811 generates information indicating the file.

In step S906, the analysis unit 811 analyzes the content of each of the files included in the input file 801 as described above. Then, the analysis unit 811 generates information indicating the consistency of the information obtained by the analysis. Such consistency verification can be performed in the same manner as in step S603 to step S606.

In step S907, the verification result generation unit 812 generates verification result data 802 indicating the results obtained in step S905 and in step S906. In this way, the file verification process ends.

By these processes, it is possible to verify the relatedness of each file included in the input file 801. In the above example, as the verification result data, information indicating a file having data based on the associated file but in which the associated file has not been found is outputted. Meanwhile, information indicating the relatedness between confirmed files may be outputted. In addition, information indicating that there is no relatedness between specific files may be outputted. In the above example, information indicating a file in which tampering has been detected can be outputted as the verification result data. Further, as the verification result data, it is possible to output information indicating items that do not match among a plurality of files.

In the above example, the input file 801 includes the files outputted by the PC 100 to 102 and the camera 110, respectively. Meanwhile, the input file 801 may include two files outputted by the PC 100 and the camera 110. In this case, it is possible to verify relatedness from the creation of the operation file by the PC 100 to the image capturing operation by the camera 110. Such verification may be performed by the PC 101. In this case, the PC 101 can then verify the previously performed operation prior to performing the image processing operation.

In this way, the PC 800 can verify that the image capturing is performed in accordance with the planned image capturing operation. That is, it is possible to confirm that the image capturing was performed in accordance with the planned image capturing operation even without the camera 110 performing verification. By the PC 800 performing such verification instead of the camera 110, the configuration of the camera 110 is simplified. Therefore, this facilitates the operation of the camera 110. Also, this facilitates miniaturization of the camera 110. It should be noted that both the camera 110 and the PC 800 may check whether or not the image capturing operation is performed in accordance with the planned image capturing operation. In this case, the items to be checked may be different between the camera 110 and the PC 800. The PC 800 is capable of outputting, together with the result of confirmation by the PC 800, information indicating the verification result by the camera 110 included in the captured image file. With such a configuration, when the operation history is verified, it is possible to verify which item has been checked by the camera 110.

### (Addition of Correction Information)

In the above-described embodiment, the respective apparatuses cannot perform editing on the acquired file. For example, the captured image file outputted from the camera 110 is electronically signed. Therefore, the PC 101 cannot edit the captured image file. Meanwhile, there is a possibility that GPS information recorded in the captured image file by the camera 110 will include an error. In such a case, the user of the PC 101 may wish to correct the GPS information to more accurately indicate the image capturing position. Such a correction can be performed after confirming that the corrected information is within an error range. In this way, it may be desirable to perform editing on metadata indicating information at the time of image capturing.

Therefore, each apparatus can add correction information to an acquired file for files generated by each apparatus. Hereinafter, a configuration in which the PC 101 adds correction information to a captured image file for a processed image file will be described.

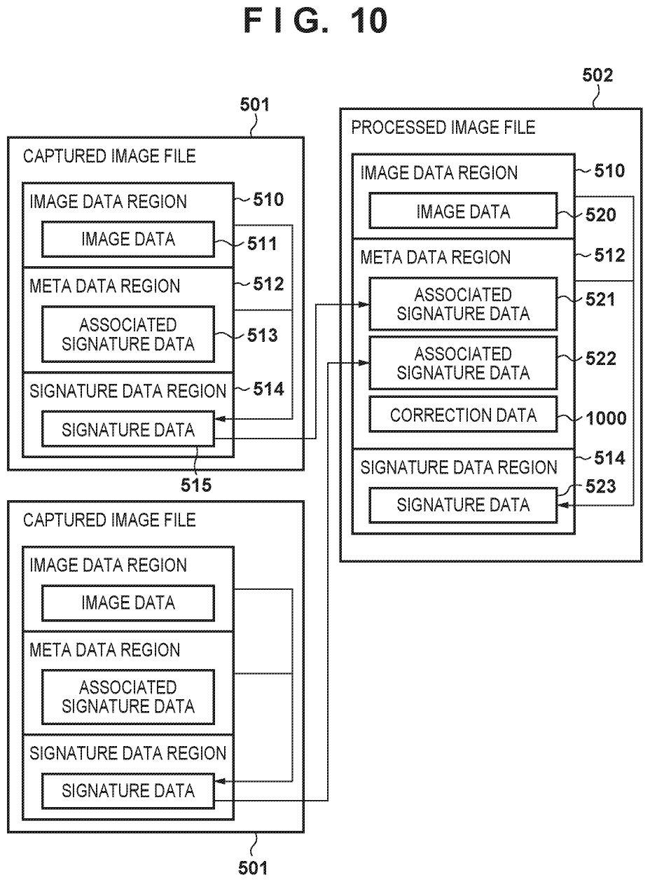

FIG. 10 is a view illustrating an example of a file structure. Items similar to those illustrated in FIG. 5 are denoted by the same reference numerals. In such a variation example, the processed image file generation unit 321 of the PC 101 adds correction data 1000 to the metadata region 512 of the processed image file 502. The correction data 1000 is, for example, correction information for GPS information included in the metadata region 512 of the captured image file 501. The processed image file 502 includes the signature data 523 for data including the correction data 1000. For this reason, it is not possible to change the correction data 1000. Such correction data 1000 remains as a history indicating that the data has been corrected.

In this case, an information processing apparatus that performs the verification, such as the PC 800, may output information indicating the correction history as verification result data. According to such a configuration, it is possible to verify an operation including a correction. Further, the apparatus that adds correction information is not limited to the PC 101, and another apparatus that performs a subsequent process may add correction information. According to this configuration, a record indicating the apparatus that performed the correction or a processing step in which the correction was performed is left. For this reason, when the verification is performed, information indicating an apparatus that performed the correction or the processing step in which correction was performed may be outputted as verification result data.

### (Variation Example of Operation File)

An operation file inputted into the camera 110 may include data based on an associated file. For example, the associated file may indicate a target site scheduled to be image captured. As an example, a reference image indicating a site on a subject that is the inspection target may be associated with the operation file. Such a reference image may be an image of a site of a subject that is the inspection target, which has been captured in the past. When an image capturing operation is performed on a site indicated by a reference image, the reference image can be associated with the operation file. In this case, associated signature data may be added to the operation file.

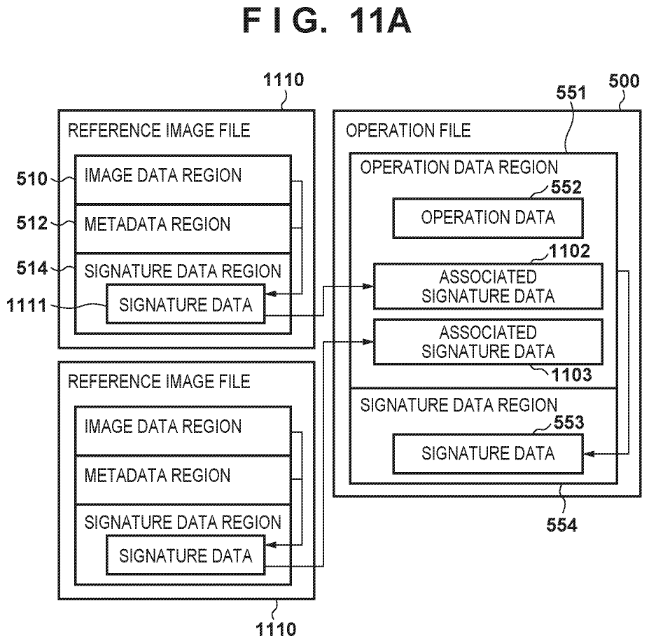

FIG. 11A illustrates an example of a file structure of a reference image file 1110 and the operation file 500 in such a variation example. Items similar to those illustrated in FIG. 5 are given the same reference numerals. The signature data region 514 of the reference image file 1110 includes signature data 1111 for some or all of the image data region 510 which indicates a reference image and the metadata region 512. The operation data region 551 of the operation file 500 includes associated signature data 1102. The associated signature data 1102 is the signature data 1111 included in the reference image file 1110. The operation file 500 may include associated signature data for a plurality of image files. In the example of FIG. 11A, the operation data region 551 further comprises associated signature data 1103.

FIG. 11B illustrates an example of data described in the operation data region 551. Item 1120 is information about a first site. In the item 1120, the signature data 1111 of the reference image file 1110 is described. Also, item 1121 is information about another site.

By referring to such an operation file and a reference image file, it is possible to confirm whether or not an image of a scheduled site has been captured. For example, by comparing a degree of matching between the reference image included in the image data region 510 in the reference image file 1110 and a captured image, it is possible to confirm whether or not the site indicated in the reference image has been captured. As another method, the position information included in the metadata region 512 in the reference image file 1110 may be compared with the image capturing position to confirm whether or not an image of the site indicated in the reference image file 1110 has been captured. Such a confirmation process can be performed by the camera 110 or the PC 800 as described above.

As described above, since the operation file has data based on the associated file, it is possible to perform more detailed verification.

### (Example of Image Capturing Operation)

The purpose of the image capturing operation is not limited. For example, the above-described embodiment can be applied to a case where an image capturing operation is performed in accordance with an image capturing plan for inspection of infrastructure. The image capturing plan may indicate that an image of a specific portion of a concrete wall of a tunnel or bridge is to be captured within a scheduled period. From a captured image thus obtained, it is possible to detect a defect such as a crack in the captured portion.

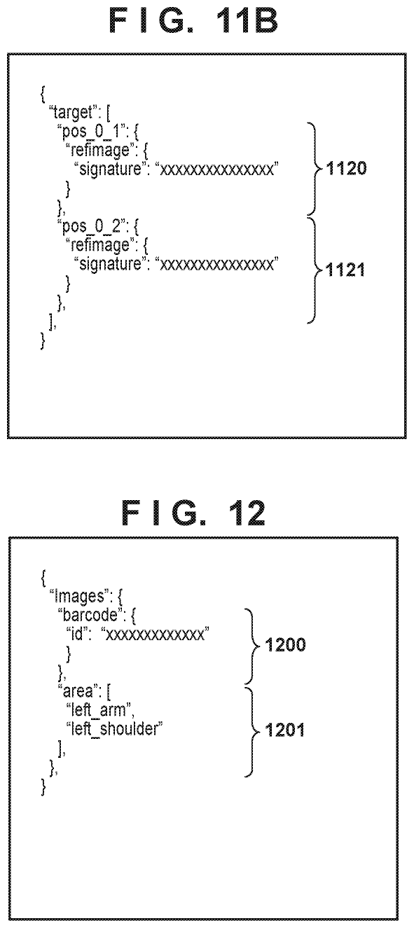

Meanwhile, the above-described embodiment is also applicable to an image capturing operation according to another image capturing plan. For example, the above-described embodiment can be applied to an image of a person captured for medical purposes. In a medical institution, a diseased site on a person's skin can be image captured for recording. FIG. 12 indicates an example of information indicating the operation content described in the operation file used in such an embodiment. Item 1200 indicates that a barcode is to be captured. The item 1200 also indicates an ID of the barcode. The barcode is information indicating a target person whose image is scheduled to be captured. For example, the patient may be wearing such a barcode. Such a barcode may also be attached to the patient's bed. Item 1201 describes the site to be subsequently image captured. In FIG. 12, the item 1201 indicates that an image of a left arm and a left shoulder is to be captured.

In image capturing in accordance with such an operation file, the barcode of the patient is first image captured, and then the affected part is image captured. In this case, by recognizing the barcode in the captured image, it is possible to determine whether or not the person specified in the operation file has been captured. In addition, by recognizing whether or not a site specified in the operation file appears in the captured image, it is also possible to determine whether or not the person has been captured. Recognition of a site appearing in a captured image can be performed using training data created in advance. For example, the training data may be, for example, a trained model capable of recognizing whether or not a specific site is included in an image. It is possible to recognize the site appearing in the captured image by using such a trained model for each site.

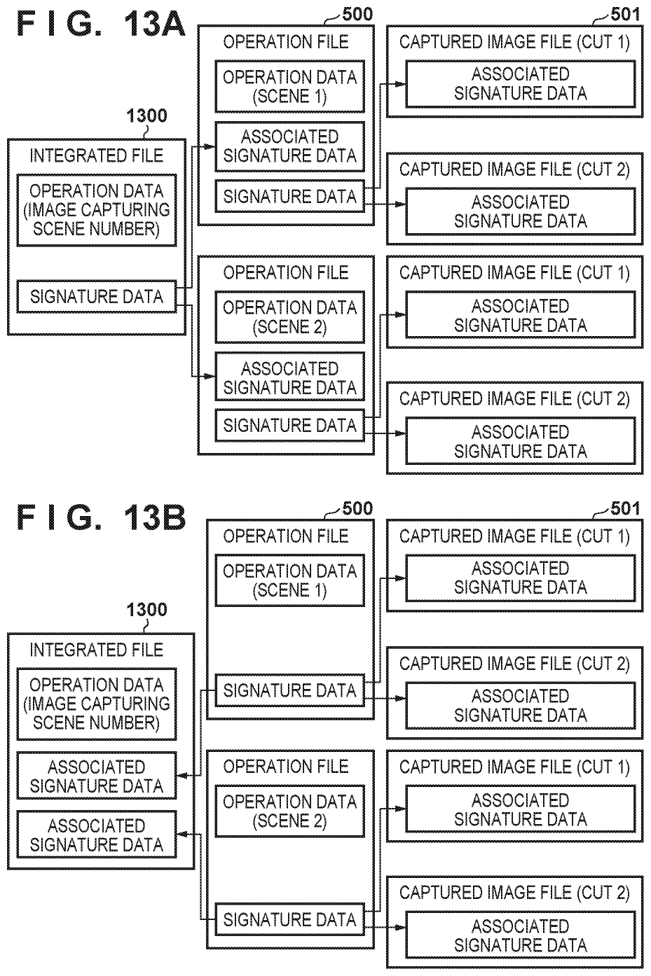

As another example, the embodiments described above are applicable to an image capturing operation for obtaining a pre-planned scene or cut. For example, the above-described embodiment can be applied to capturing of a movie. Depending on the image capturing scene, the image capturing location, the image capturing period, and performer may vary greatly. Therefore, as illustrated in FIG. 13A, a plurality of operation files 500 may be used. For example, an operation file can be prepared for each image capturing scene. At this time, information on a plurality of cuts can be described in one operation file. In the example of FIG. 13A, a plurality of captured image files each corresponding to one cut are obtained by image capturing according to one operation file.

The plurality of operation files 500 may be associated with each other. In the example illustrated in FIG. 13A, a plurality of operation files are associated with one integrated file 1300. To indicate such an association, each operation file 500 includes data based on the integrated file 1300. More specifically, the operation file 500 may include signature data of the integrated file 1300 as associated signature data.

Meanwhile, the number of image capturing scenes may be unspecified at the time of the image capturing operation. In this case, the integrated file 1300 may be created after the capturing of each scene is completed. In this case, as illustrated in FIG. 13B, data based on the respective operation files 500 is added to the integrated file 1300. More specifically, each operation file 500 may include signature data of the integrated file 1300 as associated signature data.

The operation file 500 used in the image capturing operation may include information indicating the location or time of the image capturing scene. The operation file 500 may include information indicating a performer. In such a case, by recognizing whether or not a person specified in the operation file appears in the captured image, it is also possible to determine whether or not the person has been captured. For example, by using a personal authentication technique such as face authentication, it is possible to verify whether or not a performer appears in a captured image.

As described above, by using the operation file described in accordance with the application field, it is possible to verify the image capturing operation in a plurality of fields of application.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2023-026415, filed Feb. 22, 2023, which is hereby incorporated by reference herein in its entirety.

What is claimed is:

1. An information processing apparatus comprising:
one or more memories storing instructions; and
one or more processors that execute the instructions to:
obtain image capturing plan information indicating a planned image capturing operation;
obtain image data obtained by image capturing; and
generate an electronic signature for data including the image data and hash data obtained by performing hash processing on data including the image capturing plan information.

2. The information processing apparatus according to claim 1, wherein the one or more processors execute the instructions to obtain an operation file in which the image capturing plan information is described and to which an electronic signature is added by a first other information processing apparatus.

3. The information processing apparatus according to claim 2, wherein the hash data is the electronic signature by the first other information processing apparatus.

4. The information processing apparatus according to claim 2, wherein the one or more processors execute the instructions to output an image file including the image data, the hash data, and the electronic signature for the data including the image data and the hash data.

5. The information processing apparatus according to claim 4, wherein the one or more processors execute the instructions to transmit the image file to a second other information processing apparatus for performing image processing or detection processing on the image data.

6. The information processing apparatus according to claim 1, wherein the image capturing plan information includes information indicating a scheduled image capturing period, a scheduled image capturing position, or a target of a scheduled image capture.

7. The information processing apparatus according to claim 6, wherein the one or more processors execute the instructions to generate an electronic signature for data including the image data, the hash data , and information indicating an image capturing time, image capturing position, or image capturing target for the image data.

8. The information processing apparatus according to claim 1, wherein the one or more processors execute the instructions to determine whether the image capturing conforms to the planned image capturing operation.

9. The information processing apparatus according to claim 8, wherein the one or more processors execute the instructions to determine whether the image capturing conforms to the planned image capturing operation by comparing a current time and a scheduled image capturing period indicated in the image capturing plan information.

10. The information processing apparatus according to claim 8, wherein the one or more processors execute the instructions to determine whether the image capturing conforms to the planned image capturing operation by comparing a current position and a scheduled image capturing position indicated in the image capturing plan information.

11. The information processing apparatus according to claim 8, wherein the one or more processors execute the instructions to determine whether the image capturing conforms to the planned image capturing operation by comparing information about a subject of the image capturing and information indicating a target of the scheduled image capture indicated in the image capturing plan information.

12. The information processing apparatus according to claim 11, wherein the information about the subject of the image capturing is information received from a communication device associated with the subject.

13. The information processing apparatus according to claim 8, wherein the one or more processors execute the instructions to notify that the image capturing to be performed does not conform to the planned image capturing operation.

14. The information processing apparatus according to claim 8, wherein the one or more processors execute the instructions to:
generate data indicating that the image capturing to be performed does not conform to the planned image capturing operation; and
generate an electronic signature for data including the image data, the hash data, and data indicating that the image capturing to be performed does not conform to the planned image capturing operation.

15. The information processing apparatus according to claim 1, further comprising an image sensor for generating the image data.

16. An information processing method comprising:
obtaining image capturing plan information indicating a planned image capturing operation;
obtaining image data obtained by image capturing; and
generating an electronic signature for data including the image data and hash data obtained by performing hash processing on data including the image capturing plan information.

17. A non-transitory computer-readable medium storing a program executable by a computer to perform a method comprising:
obtaining image capturing plan information indicating a planned image capturing operation;
obtaining image data obtained by image capturing; and
generating an electronic signature for data including the image data and hash data obtained by performing hash processing on data including the image capturing plan information.
